(19) United States
(12) Patent Application Publication
(10) Pub. No.: US 2016/0327903 A1
(43) Pub. Date: Nov. 10, 2016

(54) Combined projector with a diverse display effect

(71) Applicant: Yu-Ho Lin, Pingtung (TW)

(72) Inventor: Yu-Ho Lin, Pingtung (TW)

(21) Appl. No.: 15/215,612

(22) Filed: Jul. 21, 2016

(51) Int. Cl. G03H 1/00; A01K 63/06; G02B 27/08; G03H 1/04

(52) U.S. Cl. CPC G03H 1/0005; G03H 1/0443; G03H 1/0402; A01K 63/06; G02B 27/08; G03H 2001/0055; G03H 2001/0452; G03H 2001/0428

(57) ABSTRACT

A combined projector structure having a diverse stable display effect of the scene includes a holding space, in which freely-moving living organisms can be kept, an image device mounted on the edge of the holding space and facing toward the holding space. The image device can include a mounting element installed on the edge of the holding space, a kaleidoscope connected to the mounting element and facing toward the holding space, a photographic unit connected to the other end of the kaleidoscope. The photographic unit can record the scenes that appears in the other end of the kaleidoscope, and a projection unit connected to the photographic unit. Through the kaleidoscope, the displacement of the moving living organisms located in the holding space can be displayed in a diverse visual effect.

### BACKGROUND OF THE INVENTION

1. Field of the Invention

The invention relates to a combined projector structure, especially a combined projector structure having a diverse display effect of the projected object.

2. Description of Related Art

FIG. 1 is a schematic diagram disclosed in the prior patent “Ornamental structure equipped with a kaleidoscope for displaying the multiple rhythms of aquatic life”, patent number M452618, filed with the Taiwan Intellectual Property Office (TIPO). The patent applicant is also the inventor of the aforementioned prior patent. The ornamental structure 1 comprises a container body 11, in which many aquatic plants and animals can be kept, and an ornamental device 12 mounted on the edge of the container body 11, wherein the ornamental device 12 has a mounting element 121, connected to the edge of the container body 11, and a kaleidoscope 122, installed on the mounting element 121 and facing toward the container body 11. During operation, by placing colorful fishes, such as aquarium fishes, in the container body 11, and through the setting of kaleidoscope 122 to view the aquatic life in the container body 11, as fishes of different colors swim around, the kaleidoscope 122 displays a beautiful dynamic visual effect similar to that of fireworks.

After the applicant commercialized the aforementioned prior technology into products, the applicant found that the prior patent “Ornamental structure equipped with a kaleidoscope for displaying the multiple rhythms of aquatic life”, patent number M452618, can be advanced with more creative features. In other words, more versatile visual displays can be incorporated into the image displayed by the kaleidoscope 122 in order to offer an artistic presentation with multiple purposes or in wider extent, for example, a replacement of the visual art effect of traditional fireworks without the restriction of weather, terrain, or environment. As a result, the invention was invented.

### SUMMARY OF THE INVENTION

The objective of the invention is to provide a combined projector structure having a diverse stable display effect of the scene.

In order to achieve the aforementioned objective, the combined projector structure having a diverse stable display effect of the scene of the invention comprises a holding space, in which freely-moving living organisms can be kept, an image device mounted on the edge of the holding space and facing toward the holding space, wherein the image device includes a mounting element installed on the edge of the holding space, a kaleidoscope connected to the mounting element and with one end thereof facing toward the holding space, a photographic unit connected to the other end of the kaleidoscope, wherein the photographic unit can record the scene that appears in the other end of the kaleidoscope, and a projection unit connected to the photographic unit.

Therefore, the features of the invention is to use a photographic unit to record the form of movement of the living organisms inside the holding space displayed in the kaleidoscope, wherein the scene inside the kaleidoscope appears to be similar to the beautiful scene of a firework. In addition, through a projection unit, the beautiful scene photographed by the photographic unit is projected using a special projection technique, to make the visual appearance more vivid, in some cases, as vivid as objects in real life and, therefore, to create another new form of visual art.

The above and other objects, features and advantages of the invention will become apparent from the following detailed description taken with the accompanying drawings.

### BRIEF DESCRIPTION OF THE DRAWINGS

FIG. 1 is a perspective schematic diagram of prior art;

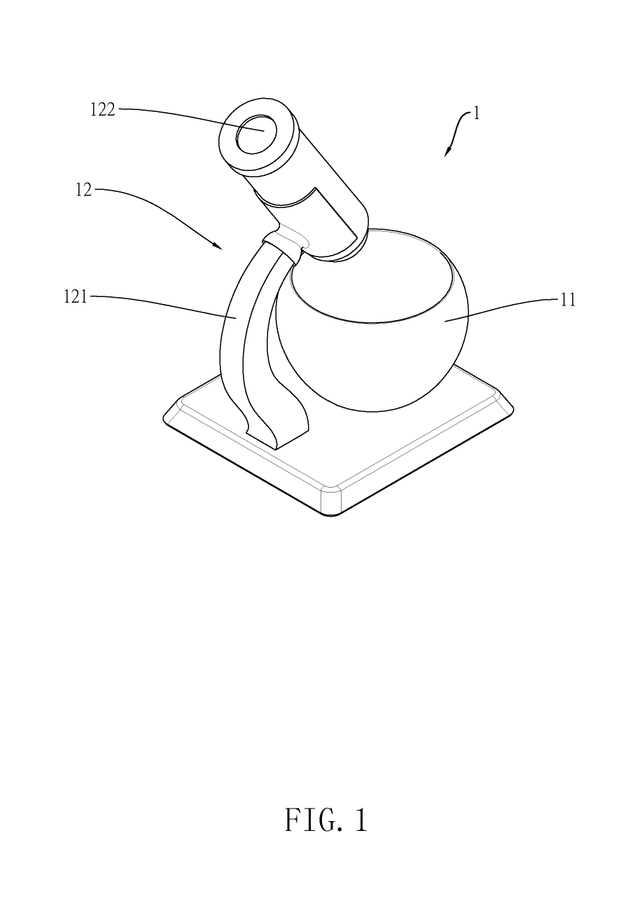

FIG. 2 is a perspective schematic diagram of the invention;

FIG. 3 is a schematic diagram of the kaleidoscope image photographed by the invention; and

FIG. 4 is a schematic diagram of the operation of the invention.

### DETAILED DESCRIPTION OF THE INVENTION

The objectives, effects, characteristics and structure of the invention will become more fully understood from the detailed description given herein below by way of preferred embodiments with reference to the accompanying drawings for illustration. Thus, the descriptions are not intended to limit the scope of the invention in any way.

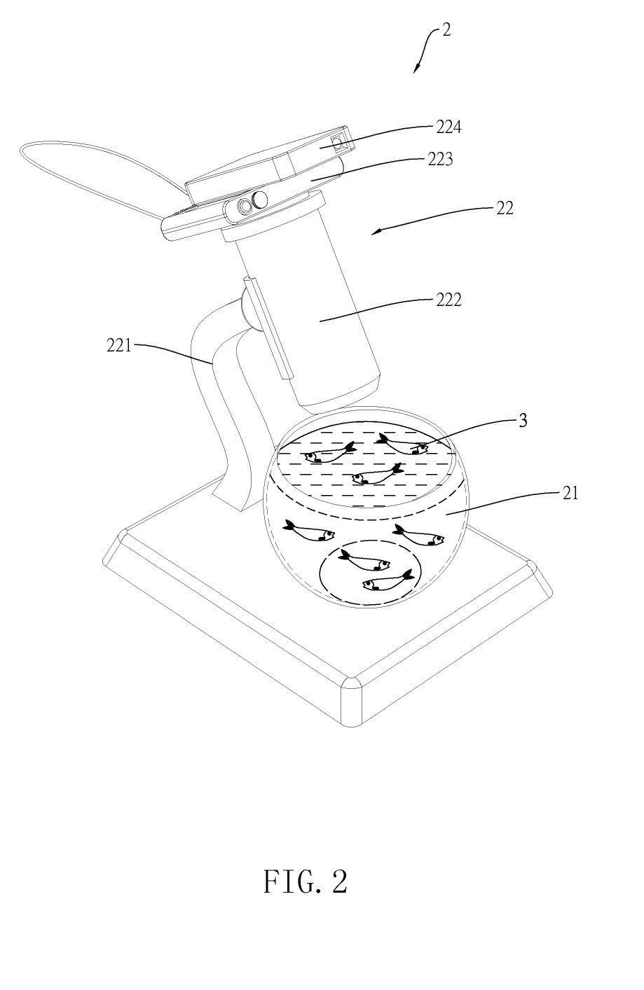

Please refer to FIG. 2. FIG. 2 is a three-dimensional schematic diagram of the invention.

As shown in FIG. 2, the combined projector structure having a diverse stable display effect of the scene 2 described by the embodiment of the invention comprises a holding space 21, in which freely-moving living organisms can be kept, and an image device 22 mounted on the edge of the holding space 21 and facing toward the holding space 21. The aforementioned holding space 21 in this embodiment can be an aquarium 21A as an example in some cases; the aquarium fishes 3 can be the freely-moving living organisms as an example in this embodiment. In other words, in the invention, colorful fishes can be kept in the aquarium, such as colorful aquarium fishes in this case.

Next, the image device 22 has a mounting element 221 installed on the edge of the holding space 21, a kaleidoscope 222 connected to the mounting element 221 and facing toward the holding space 21, a photographic unit 223 connected to the other end of the kaleidoscope 222, wherein the photographic unit 223 can record the scene that appears in the other end of the kaleidoscope 222, and a projection unit 224 connected to the photographic unit 223. The aforementioned projection unit 224 can project the beautiful scene photographed by the photographic unit 223 into the open space in a three dimensional form, using a 3D holographic projection technology, thus to give a vivid visual effect. The art of fireworks is used as an example in this embodiment.

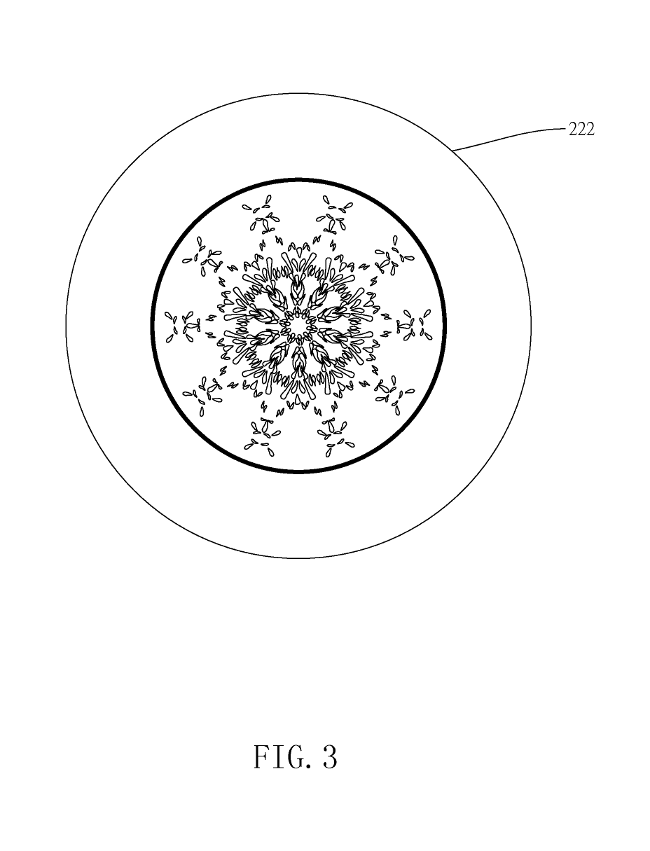

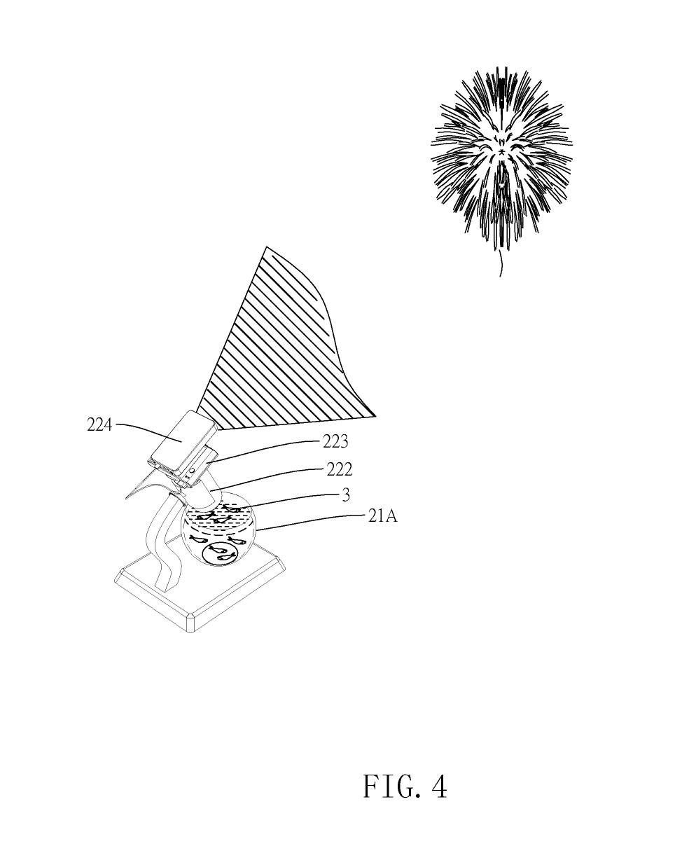

Please refer to FIG. 3 and FIG. 4 together. FIG. 3 is the schematic diagram of the kaleidoscope 222 image photographed by the invention. FIG. 4 is the schematic diagram of the operation of the invention.

As shown in FIG. 3 and FIG. 4, during operation, place aquarium fishes 3 in the aquarium 21A and use the kaleidoscope 222 to transform the swimming movements of the aquarium fishes 3 into an effect of multiple images. Whenever the aquarium fishes 3 make slight movements, countless different forms of image are generated synchronously through the kaleidoscope 222, so that the produced visual presentation has diverse visual effects. Next, by the use of photographic unit 223, images in the kaleidoscope 222 are recorded. Last, the projection unit 224 projects the image photographed by the photographic unit 223 into the open space, displaying the image photographed by the photographic unit 223 in a three dimensional form, using a holographic projection technology. In other words, through the special setting of the projection unit 224 and the special media (not shown in the diagram) or the characteristics of the special media, the holographic projection technology displays a three dimensional image by means of the special media. The aforementioned special media can be scrims or optical lenses, or other media with an equivalent effect, allowing audiences to view the dynamic changing image of the aquarium fishes 3 in a 3D holographic form.

The holographic technology can also be implemented by adding a laser device (not shown in the diagram) to the projection unit 224, wherein the laser device transmits infrared laser beams of high power to quickly scan the location for projection. By means of projecting photon light that is focused and coordinated into the image to be displayed and due to the persistence of vision effect, audiences are able to see the image photographed by the photographic unit 223 in a three dimensional form over an open space, similar to the visual effect of the fireworks. The effect of the visual art of the invention can animate the real fireworks in an outdoor event and meet the objective of the invention.

In summary, advantages of the combined projector structure having a diverse stable display effect of the scene of the invention are as follows:

Using the photographic unit and the projection unit, the scene in the kaleidoscope can be displayed in a three-dimension art appearance with more striking impression.

The scene in the kaleidoscope can be projected into a three-dimensional holographic image to animate the effect of fireworks and to avoid the disadvantages created by using the traditional fireworks. For example, the disadvantages include the gaseous waste that can cause air pollution easily, and the waste generated by the fireworks that can cause pollution to the environment.

When the weather is not in a fair condition, the original designed effect of the fireworks usually can not be achieved, or the fireworks may not be completely ignited. As a result, audiences can not fully perceive the beauty of the supposed original art design. On the contrary, the invention can animate the real fireworks in an open space to the art effect of an original firework without the restriction of the weather condition.

Through the simple combined structure of the invention, the invention has the advantages of convenience and repeat use, meets the goal of environmental protection, and reduces the cost, compared to that of a traditional firework.

The invention uses the kaleidoscope to create an effect of multiple images. Therefore, the variation of image can be unlimited. Compared to the forms and color display of the traditional fireworks, the invention offers more varieties of form, color, and effect.

Therefore, the invention has much more advancements and implementations than other similar products in the same category. At the same time, after thoroughly searching domestic and foreign publications related to the technology of this type of structure, it is concluded that no identical or similar structures exist in the patents approved prior to the submission of the application of the invention. Thus, the invention meets the key requirements of “novelty”, “progress” and “applicable to industrial use” and, therefore, hereby the application is submitted.

While the invention has been described in terms of preferred embodiments, those skilled in the art will recognize that the invention can be practiced with modifications within the spirit and scope of the appended claims.

What is claimed is:

1. A combined projector structure having a diverse stable display effect of the scene, comprising:
a holding space wherein freely-moving living organisms can be kept;
an image device mounted on the edge of the holding space and facing toward the holding space
wherein the image device has a mounting element installed on the edge of the holding space, and a kaleidoscope connected to the mounting element and facing toward the holding space, having the features that the image device further has a photographic unit connected to the other end of the kaleidoscope, and
wherein the photographic unit can record the scenes that appears in the other end of the kaleidoscope, and a projection unit connected to the photographic unit.

2. The combined projector structure having a diverse stable display effect of the scene as claimed in claim 1, wherein the holding space can be an aquarium.

3. The combined projector structure having a diverse stable display effect of the scene as claimed in claim 2, wherein the moving living organisms kept in the holding space can be fishes of different colors.

4. The combined projector structure having a diverse stable display effect of the scene as claimed in claim 2, wherein the fishes of different colors can be colorful aquarium fishes.

5. The combined projector structure having a diverse stable display effect of the scene as claimed in claim 1, wherein the projection unit can display the images recorded by the photographic unit in a holographic projection method.
